(19) United States
(12) Patent Application Publication
(10) Pub. No.: US 2011/0076483 A1
(43) Pub. Date: Mar. 31, 2011

(54) SEMICONDUCTOR PHOSPHOR NANOPARTICLE INCLUDING SEMICONDUCTOR CRYSTAL PARTICLE MADE OF 13TH FAMILY-15TH FAMILY SEMICONDUCTOR

(76) Inventor: Tatsuya RYOWA, Osaka (JP)

(21) Appl. No.: 12/835,371

(22) Filed: Jul. 13, 2010

(30) Foreign Application Priority Data
Sep. 30, 2009 (JP) 2009-227103(P)

(51) Int. Cl. H01B 1/00; B32B 5/16

(52) U.S. Cl. 428/328; 977/815

(57) ABSTRACT

Disclosed is a semiconductor phosphor nanoparticle including a semiconductor crystalline particle made of a 13th family-15th family semiconductor, a modified organic compound binding to the semiconductor crystalline particle, and a layered compound sandwiching the semiconductor crystalline particle protected with the modified organic compound.

This nonprovisional application is based on Japanese Patent Application No. 2009-227103 filed on Sep. 30, 2009 with the Japan Patent Office, the entire contents of which are hereby incorporated by reference.

### BACKGROUND OF THE INVENTION

1. Field of the Invention

The present invention relates to a semiconductor phosphor nanoparticle, and particularly to a semiconductor phosphor nanoparticle having an improved luminous intensity and luminous efficiency.

2. Description of the Background Art

It is known that a semiconductor crystalline particle (hereinafter, also referred to as “crystalline particle”) exhibits quantum size effect by decreasing a mean particle diameter thereof to the diameter that is nearly the same as the Bohr radius. Quantum size effect means that when the particle diameter of the crystalline particle decreases, it becomes impossible for electrons to freely move and therefore to have only a specific energy.

C. B. Murray et al. (Journal of the American Chemical Society), 1993, 115, pp. 8706-8715 describes, as a technology utilizing the quantum size effect, a phosphor using a crystalline particle made of a 12th family-16th family compound semiconductor. Since this phosphor has nearly the same size as the exciton Bohr radius, it is possible to shorten the wavelength of light generated as the size is decreased.

However, since a phosphor having a mean particle diameter of 100 nm or less is likely to aggregate because of high surface activity, it is difficult to stably disperse the phosphor. It is also difficult to separate and purify only the phosphor from the raw material thereof when the phosphor having such a mean particle diameter is synthesized.

Therefore, Japanese Patent Laying-Open No. 2008-063427 proposes a technology where a phosphor is isolated by modifying a surface of a crystalline particle with a protective agent made of an organic low-molecular compound. However, a dispersion of the phosphor causes aggregation of the phosphor at room temperature within a week. Even when the crystalline particle is modified with the organic low-molecular compound in such a manner, the dispersion of the phosphor exhibited insufficient stability.

As a trial of improving stability of the dispersion, Japanese Patent Laying-Open No. 2008-063427 proposes a technology where a semiconductor nanoparticle modified with an organic low-molecular compound and a vinyl-based thermoplastic resin having a mercapto group at the terminal are allowed to coexist. By using the vinyl-based thermoplastic resin having a mercapto group at the terminal, it is possible to maintain a state where semiconductor nanoparticles are uniformly dispersed and to make them hard to aggregate.

However, the organic substance that protects the surface of the semiconductor nanoparticle may deteriorate, and the organic substance may be peeled off from the semiconductor nanoparticle to cause a surface defect such as a dangling-bond (unbound hand) on an outermost surface of the semiconductor nanoparticle, resulting in deterioration of luminous efficiency.

Under these circumstances, the present invention has been made and an object thereof is to provide a semiconductor phosphor nanoparticle having a high luminous efficiency and excellent in reliability by suppressing a surface defect such as a dangling-bond of an outermost surface of a semiconductor nanoparticle.

### SUMMARY OF THE INVENTION

The semiconductor phosphor nanoparticle of the present invention includes a semiconductor crystalline particle made of a 13th family-15th family semiconductor, a modified organic compound bonding to the semiconductor crystalline particle, and a layered compound sandwiching the semiconductor crystalline particle protected with the modified organic compound.

The layered compound is preferably made of metal oxide. The semiconductor crystalline particle has a mean particle diameter that is two times or less the Bohr radius.

The semiconductor crystalline particle is preferably made of a 13th family nitride semiconductor, more preferably made of indium nitride, and still more preferably made of a 13th family mixed crystal semiconductor.

The modified organic compound preferably has a hetero atom and the modified organic compound is more preferably amine, and the modified organic compound has still more preferably a straight-chain alkyl group.

The semiconductor crystalline particle preferably includes a semiconductor crystal core, and a shell layer coating the semiconductor crystal core, and the shell layer preferably has a laminate structure composed of two or more layers.

With the constitution, the semiconductor phosphor nanoparticle of the present invention can stably cap a surface defect of a semiconductor crystal. Accordingly, it is possible to suppress inactivation of an excitation energy on a surface of a semiconductor crystalline particle, and thus the semiconductor phosphor nanoparticle has effect such as a high luminous efficiency and excellent reliability.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing a basic structure of a semiconductor phosphor nanoparticle of the present invention.

FIG. 2 is a view schematically showing a basic structure of a semiconductor phosphor nanoparticle where a semiconductor crystalline particle has a core/shell structure.

FIG. 3 is a view schematically showing a basic structure of a semiconductor phosphor nanoparticle produced in Comparative example 1.

### DESCRIPTION OF THE PREFERRED EMBODIMENTS

### First Embodiment

The present invention will be described in more detail below. While the description is made with reference to the accompanying drawings in the following description of embodiments, constituents represented by the identical reference symbol denote the identical portions or corresponding portions in the drawings of the present specification. Since relationship between dimensions such as length, size and width in the drawings is appropriately varied for clarity and simplification, the dimensions are not actual dimensions.

<Semiconductor Phosphor Nanoparticle>

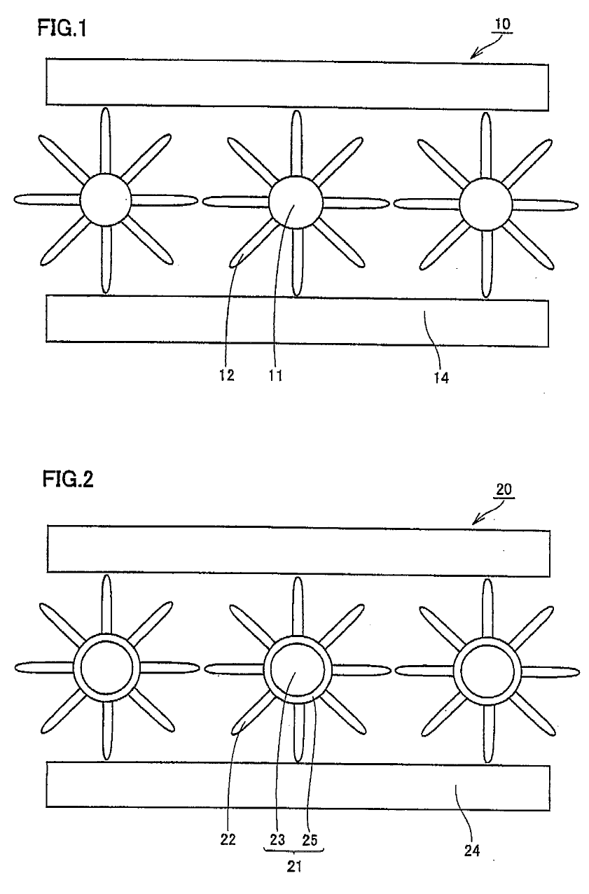

FIG. 1 is a sectional view schematically showing one preferred example of a basic structure of a semiconductor phosphor nanoparticle according to the present embodiment. As shown in FIG. 1, a semiconductor phosphor nanoparticle 10 of the present embodiment includes a semiconductor crystalline particle 11, a modified organic compound 12 coating semiconductor crystalline particle 11, and a layered compound 14 sandwiching modified organic compound 12 between layers. In such a manner, by coating semiconductor crystalline particle 11 with modified organic compound 12 and layered compound 14, it is possible to suppress activation of an excitation energy on a surface of semiconductor crystalline particle 11, thus making it possible to improve a luminous efficiency of semiconductor phosphor nanoparticle 10. Each constitution of these semiconductor phosphor nanoparticles 10 will be described below.

<Semiconductor Crystalline Particle>

In semiconductor phosphor nanoparticle 10 of the present embodiment, semiconductor crystalline particle 11 is a nanoparticle made of a 13th family-15th family semiconductor. The “13th family-15th family semiconductor” as used herein means a semiconductor where a 13th family element (B, Al, Ga, In, Tl) and a 15th family element (N, P, As, Sb, Bi) are bound. The “nanoparticle” is a nanoparticle having a diameter of several nanometers or more and several thousands of nanometers or less.

The 13th family-15th family semiconductor used for semiconductor crystalline particle 11 is preferably one or more selected from the group consisting of InN, InP, InGaN, InGaP, AlInN, AlInP, AlGaInN and AIGaInP, and more preferably one or more selected from the group consisting of InN, InP, InGaN and InGaP.

The 13th family-15th family semiconductor used for semiconductor crystalline particle 11 may include unintended impurities, and impurities may be intentionally added as long as the concentration thereof is 1×10¹⁶ cm⁻³ or more and 1×10²¹ cm⁻³ or less. When impurities are intentionally added to the 13th family-15th family semiconductor, any of a 2th family element (Be, Mg, Ca, Sr, Ba), Zn or Si is preferably added as a dopant and, among them, any of Mg, Zn or Si is more preferably used as the dopant.

Since the 13th family-15th family semiconductor with such a composition has a band gap energy that emits visible light, it is possible to adjust a luminous wavelength of semiconductor crystalline particle 11 to a wavelength within arbitrary wavelength range of visible light by controlling a particle diameter of a nanoparticle and a mixed crystal ratio thereof.

A band gap of the 13th family-15th family semiconductor used for semiconductor crystalline particle 11 varies depending on a luminous wavelength of semiconductor phosphor nanoparticle 10, but is preferably 1.8 eV or more and 2.8 eV or less. Describing in more specifically, when semiconductor phosphor nanoparticle 10 is used as a red phosphor, the band gap of the 13th family-15th family semiconductor is preferably 1.85 eV or more and 2.5 eV or less. When semiconductor phosphor nanoparticle 10 is used as a green phosphor, the band gap of the 13th family-15th family semiconductor is preferably 2.3 eV or more and 2.5 eV or less. When semiconductor phosphor nanoparticle 10 is used as a blue phosphor, the band gap of the 13th family-15th family semiconductor is preferably 2.65 eV or more and 2.8 eV or less.

Semiconductor crystalline particle 11 is preferably made of a 13th family nitride semiconductor, and more preferably indium nitride. Accordingly, it is possible to realize arbitrary visible luminescence when a mean particle diameter of semiconductor phosphor nanoparticle 10 is controlled.

Semiconductor crystalline particle 11 may also be made of a 13th family mixed crystal nitride semiconductor. It is possible to realize arbitrary visible luminescence by using semiconductor crystalline particle 11 of such a material when the mean particle diameter and the mixed crystal ratio thereof are controlled.

The mean particle diameter of semiconductor crystalline particle 11 used in the present embodiment is preferably 0.1 nm or more and 100 nm or less, more preferably 0.5 nm or more and 50 nm or less, and still more preferably 1 to 20 nm. By using semiconductor crystalline particle 11 having such a mean particle diameter, it is possible to suppress scattering of excitation light on a surface layer of semiconductor crystalline particle 11, and to absorb excitation light to semiconductor crystalline particle 11. When the mean particle diameter of semiconductor crystalline particle 11 is less than 0.1 nm, since the particle diameter is too small, aggregation is likely to arise between semiconductor crystalline particles 11. In contrast, when the mean particle diameter is more than 100 nm, since excitation light scatters, a luminous efficiency deteriorates, and therefore it is not preferred.

The mean particle diameter of semiconductor crystalline particle 11 is preferably two times or less the Bohr radius. The “Bohr radius” as used herein means extension of existence probability of an exciton and is represented by the following Mathematical expression (1):

y=4π∈h²·me² Expression (1)

where the respective symbols in the expression (1) denote as follows: y: Bohr radius, ∈: dielectric constant, h: Planck's constant, m: effective mass, and e: charge elementary quantity. As a result of calculation based on this Mathematical expression, the Bohr radius of GaN is about 3 nm and the Bohr radius of InN is about 7 nm.

When semiconductor crystalline particle 11 has the mean particle diameter that is two times or less the Bohr radius, it is possible to extremely improve a luminous intensity of semiconductor phosphor nanoparticle 10. When semiconductor crystalline particle 11 is used as semiconductor phosphor nanoparticle 10, if the mean particle diameter of semiconductor crystalline particle 11 is two times or less the Bohr radius, the band gap tends to extend due to the quantum size effect. Even in this case, the band gap of the 13th family-15th family semiconductor constituting semiconductor crystalline particle 11 is preferably within the above numerical value range.

The mean particle diameter of semiconductor crystalline particle 11 can be calculated based on a spectrum half-value width due to X-ray diffraction measurement, and also can be calculated by directly observing a lattice image of semiconductor crystalline particle 11 based on an observed image with a high magnification using a transmission electron microscope (TEM).

<Modified Organic Compound>

In the present embodiment, modified organic compound 12 is preferably a compound having a hydrophilic group and a hydrophobic group in a molecule. When modified organic compound 12 has a hydrophilic group and a hydrophobic group, a dangling-bond (unbound hand) on a surface of semiconductor crystalline particle 11 is capped by modified organic compound 12, thus making it possible to firmly bond semiconductor crystalline particle 11 with modified organic compound 12. In such a manner, when a surface of semiconductor crystalline particle 11 is capped by modified organic compound 12, a surface defect of semiconductor crystalline particle 11 is suppressed, thus making it possible to improve a luminous efficiency of semiconductor phosphor nanoparticle 10.

It is possible to use, as modified organic compound 12, an organic compound having a nitrogen-containing functional group, a sulfur-containing functional group, an acidic group, an amide group, a phosphine group, a phosphine oxide group, a hydroxyl group or a straight-chain alkyl group. Examples of modified organic compound 12 include triethanolamine lauryl sulfate, lauryl diethanolamide, dodecyltrimethylammonium chloride, trioctylphosphine, trioctylphosphine oxide and dodecanethiol. It is preferred to use modified organic compound 12 having a straight-chain alkyl group among these groups so as to decrease steric hindrance between modified organic compounds 12 when modified organic compound 12 is bound to a surface of semiconductor crystalline particle 11.

Modified organic compound 12 preferably has a hetero atom. Accordingly, it is possible to firmly bond modified organic compound 12 to a surface of semiconductor crystalline particle 11. As used herein, the “hetero atom” means all atoms excluding a hydrogen atom and a carbon atom.

Modified organic compound 12 is preferably an amine compound that has a non-polar hydrocarbon terminal as a hydrophobic group, and an amino group as a hydrophilic group. When a hydrophilic group of modified organic compound 12 is an amino group, the amine group is firmly bound to a metal element on a surface of semiconductor crystalline particle 11.

Examples of the amine that is effective as modified organic compound 12 include butylamine, t-butylamine, isobutylamine, tri-n-butylamine, triisobutylamine, triethylamine, diethylamine, hexylamine, dimethylamine, laurylamine, octylamine, tetradecylamine, hexadecylamine, oleylamine, tripentylamine, trihexylamine, triheptylamine, trioctylamine, trinonylamine, tridecylamine and triundecylamine.

A thickness of modified organic compound 12 bonding to semiconductor crystalline particle 11 can also be estimated by observing an observed image with a high magnification using TEM.

<Layered Compound>

In the present embodiment, layered compound 14 is a compound having a two-dimensional crystal structure, and can sandwich semiconductor crystalline particle 11 capped by modified organic compound 12 between layers. By sandwiching semiconductor crystalline particle 11 between layers in such a manner, semiconductor crystalline particle 11 can be stabilized, thereby making semiconductor crystalline particles 11 hard to aggregate. Moreover, since a surface defect of semiconductor crystalline particle 11 can be suppressed, the luminous efficiency of semiconductor phosphor nanoparticle 10 can be improved.

It is preferred to use, as layered compound 14, a metal oxide or inorganic layered compound. It is more preferred to use a metal oxide so as to prevent permeation of water and oxygen in air. It is possible to use, as the metal oxide, layered molybdenum oxide, layered vanadium oxide, layered titanium oxide, layered manganese oxide and layered zirconium oxide. It is possible to use, as the inorganic layered compound, graphite, metal chalcogenide, metal oxyhalide, metal phosphate and double hydroxide.

A size of layered compound 14 can be confirmed by observing an observed image with a high magnification using TEM.

<Luminescence of Semiconductor Phosphor Nanoparticle>

In semiconductor phosphor nanoparticle 10, modified organic compound 12 is bound to a metal element having an unbound hand arranged on a surface of semiconductor crystalline particle 11. With the constitution, a dangling-bond on the surface of semiconductor crystalline particle 11 is efficiently capped.

When semiconductor phosphor nanoparticle 10 is irradiated with excitation light, semiconductor crystalline particle 11 is excited by absorbing excitation light. Herein, since the particle diameter of semiconductor crystalline particle 11 is small enough to have the quantum size effect, semiconductor crystalline particle 11 can have a plurality of scattered energy levels, but sometimes has one energy level. A light energy absorbed and excited by semiconductor crystalline particle 11 transits between a ground level of a conduction band and a ground level of a valence band, and light having a wavelength corresponding to the energy is emitted from semiconductor crystalline particle 11.

According to semiconductor phosphor nanoparticle 10 of the present embodiment, a dangling-bond on a surface of the semiconductor crystalline particle 11 is capped by modified organic compound 12 and is further held by layered compound 14, and thus a surface defect of semiconductor crystalline particle 11 is suppressed. Accordingly, since semiconductor crystalline particle 11 can have high confinement effect of an excitation carrier thus generated and can suppress inactivation of an excitation energy on the surface, it is possible to provide a semiconductor phosphor nanoparticle having a high luminous efficiency and excellent in reliability.

<Method for Producing Semiconductor Phosphor Nanoparticle>

The method of producing a semiconductor phosphor nanoparticle of the present embodiment is not particularly limited and any production method can be used. In view of a simple and easy technology and low cost, a chemical synthesis method is preferably used. The chemical synthesis method is a method where plural starting substances containing a constituent element of a product substance are reacted after dispersing on a medium to obtain an objective product substance. Specific examples of the chemical synthesis method include a sol-gel method (a colloidal method), a hot soap method, a reversed micelle method, a solvothermal method, a molecular precursor method, a hydrothermal synthetic method and a flux method.

A method of producing a semiconductor phosphor nanoparticle using a hot soap method will be described below. The hot soap method is suited for producing a nanoparticle made of a compound semiconductor material.

First, semiconductor crystalline particle 11 is subjected to a liquid-phase synthesis. For example, when semiconductor crystalline particle 11 made of InN is produced, a flask or the like is filled with 1-octadecene as a synthetic solvent, and then tris(dimethylamino)indium is mixed with hexadecylamine (HDA). After well mixing of the mixed solution, the mixed solution is reacted at a synthesis temperature of 180 to 500° C., thereby coating semiconductor crystalline particle 11 made of InN with modified organic compound 12 made of HDA.

Herein, a compound solution made from a carbon atom and a hydrogen atom (hereinafter, also referred to as a “hydrocarbon-based solvent”) is preferably used as the synthetic solvent used in the hot soap method. When a solvent other than the hydrocarbon-based solvent is used as the synthetic solvent, water and oxygen are incorporated into the synthetic solvent and semiconductor crystalline particle 11 is oxidized, and therefore it is not preferred. Herein, examples of the hydrocarbon-based solvent include n-pentane, n-hexane, n-heptane, n-octane, cyclopentane, cyclohexane, cycloheptane, benzene, toluene, o-xylene, m-xylene and p-xylene.

In the hot soap method, a core size grows largely as a reaction time becomes longer, theoretically. Therefore, a size of semiconductor crystalline particle 11 made of InN can be controlled to a desired size by performing a liquid-phase synthesis while monitoring the core size by photoluminescence, light absorption or dynamic light scattering.

Next, a powdered metal oxide is used as a raw material and prepared in a polar solvent to obtain two-dimensional layered compound 14. Herein, either an inorganic polar solvent or an organic polar solvent may be used as a polar solvent. As the inorganic polar solvent, for example, water is preferably used. As the organic polar solvent, for example, dimethylformamide, alcohol, dimethyl sulfoxide, acetonitrile, methyl alcohol and ethanol are preferably used.

A solvent containing semiconductor crystalline particle 11 is mixed with a solvent containing layered compound 14 obtained. Semiconductor crystalline particle 11 is protected with layered compound 14 by stirring or shaking the mixed solvent using an ultrasonic treatment or a stirrer. The semiconductor phosphor nanoparticle of the present embodiment can be obtained by the steps described above.

### Second Embodiment

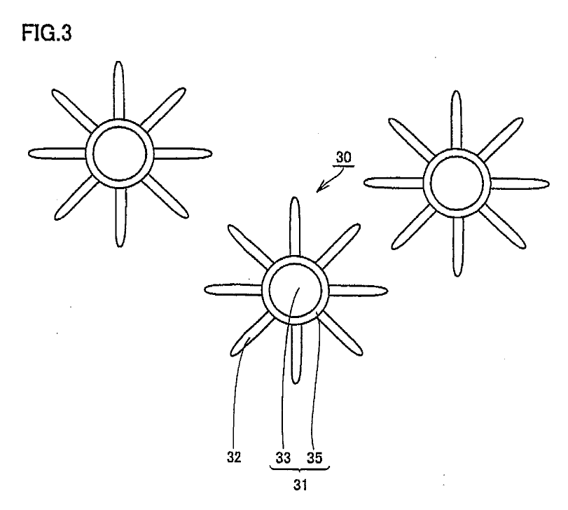

The semiconductor phosphor nanoparticle of the present embodiment is characterized by using a semiconductor crystalline particle having a core/shell structure. FIG. 2 is a view schematically showing a basic structure of a semiconductor phosphor nanoparticle where a semiconductor crystalline particle has a core/shell structure.

In a semiconductor phosphor nanoparticle 20 of the present embodiment, as shown in FIG. 2, a semiconductor crystalline particle 21 includes a semiconductor crystal core 23, and a shell layer 25 coating semiconductor crystal core 23.

Semiconductor phosphor nanoparticle 20 of the present embodiment includes a modified organic compound 22 binding to a surface of shell layer 25, and a layered compound 24 containing semiconductor crystalline particle 21 protected with modified organic compound 22. Semiconductor phosphor nanoparticle 20 of the present embodiment will be described below.

<Shell Layer>

When semiconductor crystalline particle 21 has a core/shell structure, shell layer 25 is a layer formed by the growth of a semiconductor crystal on a surface of semiconductor crystal core 23, and semiconductor crystal core 23 and shell layer 25 are bound by a chemical bond. Shell layer 25 is made of a compound semiconductor formed while taking over a crystal structure of semiconductor crystal core 23.

A semiconductor constituting shell layer 22 is preferably made of a 13th family-15th family semiconductor or a 12th family-16th family semiconductor and, for example, it is preferred to use one or more selected from the group consisting of GaAs, GaP, GaN, GaSb, InAs, InP, InN, InSb, AlAs, AlP, AlSb, AlN, ZnO, ZnS, ZnSe and ZnTe.

When a particle diameter of semiconductor crystal core 23 is estimated as 2 to 6 nm, a thickness of shell layer 25 is preferably within a range from 0.1 nm to 10 nm. When the thickness of shell layer 25 is less than 0.1 nm, since it is impossible to sufficiently coat a surface of semiconductor crystal core 23, semiconductor crystal core 23 cannot be uniformly protected. In contrast, when the thickness of shell layer 25 is more than 10 nm, it becomes difficult to uniformly control the thickness of shell layer 25 and a defect increases on the surface, and thus it is not preferred in view of raw material cost.

Herein, the thickness of shell layer 25 can be measured by X-ray diffraction, and also can be estimated by observing a lattice image through an observed image with a high magnification using TEM. The thickness of shell layer 25 is proportional to a particle number of semiconductor crystal core 23 and a mixing ratio of raw materials of shell layer 25.

Shell layer 25 is not limited only to a single-layered structure, and may have a laminate structure composed of plural layers. Using shell layer 25 having a laminate structure, semiconductor crystal core 23 can be surely coated. When shell layer 25 has a laminate structure, the thickness of shell layer 25 increases in proportional to the particle number of semiconductor crystal core 23 and a mixing ratio of the raw material constituting the laminate structure.

<Method for Producing Semiconductor Phosphor Nanoparticle>

A method of producing a semiconductor phosphor nanoparticle of the present embodiment will be described below. First, semiconductor crystal core 23 is produced by using the same method as that of forming the semiconductor crystalline particle of the first embodiment. Then, by adding a reaction reagent and modified organic compound 22 as raw materials of shell layer 25 to a solution containing semiconductor crystal core 23 and heating them, shell layer 25 is synthesized on a surface taking over a crystal structure of semiconductor crystal core 23.

To a surface of shell layer 25 thus synthesized, modified organic compound 22 is chemically bound. By coating a surface of shell layer 25 with modified organic compound 22, a surface defect such as a dangling-bond on a surface of shell layer 25 can be capped. Modified organic compound 22 may be added in the solution after growing shell layer 25. Semiconductor phosphor nanoparticle 20 of the present embodiment can be obtained by the foregoing steps. The present invention will be described in more detail by way of Examples, but the present invention is not limited thereto.

### EXAMPLES

### Example 1

In the present Example, a semiconductor phosphor nanoparticle capable of absorbing excitation light to emit red light was prepared by a hot soap method. As shown in FIG. 2, semiconductor phosphor nanoparticle 20 includes semiconductor crystal core 23 made of InN, shell layer 25 made of GaN, modified organic compound 22 made of hexadecylamine (HDA) and layered compound 24 made of vanadium oxide. A method for producing the same will be described specifically below.

First, semiconductor crystal core 23 made of an InN crystal was synthesized by a thermal decomposition reaction of 1 mmol of tris(dimethylamino)indium and 2 mmol of HDA in 30 ml of a 1-octadecene solution. By adjusting a mean particle diameter of semiconductor crystal core 23 to 5 nm, a luminous wavelength was adjusted to 620 nm so as to exhibit red luminescence.

As a result of the measurement of semiconductor crystal core 23 by X-ray diffraction, a mean particle diameter of a semiconductor crystal core estimated from a spectrum half-value width was 5 nm The mean particle diameter of semiconductor crystal core 23 was calculated by using the following Scherrer's formula (Mathematical expression (2)):

B=λ/Cos θ·R Mathematical expression (2)

where the respective symbols in the expression (2) denote as follows B: X-ray half-value width [deg], λ: X-ray wavelength [nm], θ: Bragg angle [deg], and n: particle diameter [nm].

Next, the reaction was performed by adding 30 ml of a 1-octadecene solution containing 7 mmol of tris(dimethylamino)gallium to a solution containing semiconductor crystal core 23 to form shell layer 25 on a surface of semiconductor crystal core 23. Semiconductor crystalline particle 21 thus produced was coated with modified organic compound 22 made of HDA. Furthermore, the reaction was performed by adding a layered vanadium oxide prepared in ethanol to form layered compound 24 on a surface of modified organic compound 22.

In such a manner, semiconductor phosphor nanoparticle 20 with a constitution of InN (semiconductor crystal core 23)/GaN (shell layer 25)/HDA (modified organic compound 22)/V₂O₅ (layered compound 24) was produced. The notation “A/B” means A coated with B.

The semiconductor phosphor nanoparticle thus produced can be used as a red phosphor since it absorbs light having a particularly high external quantum efficiency and a wavelength of 405 nm using a blue light emitting device made of a 13th family nitride as an excitation light source to emit red light.

Relative to the semiconductor phosphor nanoparticle obtained in Example 1, a luminous intensity of light having a wavelength of 620 nm was measured by using a fluorescence spectrophotometer (product name: FluoroMax 3 (manufactured by HORIBA, Ltd., manufactured by JOBIN YVON S.A.S.)). As a result, a high luminous intensity of about 90 a.u. (arbitrary unit) was obtained.

Thus, it has found that the semiconductor phosphor nanoparticle of Example 1 exhibits the quantum size effect and has a high luminous efficiency. It is considered that a surface defect of the shell layer was stably capped by coating the surface of the shell layer with the modified organic compound and the layered compound. Characteristics of the semiconductor phosphor nanoparticle of Example 1 are shown in Table 1 below.

TABLE 1

| | Nanoparticle core | | | | | | | |
|---|---|---|---|---|---|---|---|---|
| | | Mean | | Modified | | Excitation | | |
| | | particle | Shell | organic | Layered | light | Luminous | Luminous |
| | | diameter | layer | compound | compound | wavelength | wavelength | intensity |
| | Material | (nm) | (material) | (material) | (material) | (nm) | (nm) | (a.u.) |
| Example 1 | InN | 5 | GaN | Hexadecylamine | Vanadium oxide | 405 | 620 | 90 |
| Example 2 | InN | 4 | — | Dodecanethiol | Molybdenum oxide | 405 | 520 | 70 |
| Example 3 | InN | 3 | ZnS | Octylamine | Molybdenum disulfide | 405 | 470 | 80 |
| Example 4 | In_{0.3}Ga_{0.7}N | 5 | GaN | Trioctylamine | Manganese oxide | 405 | 480 | 85 |
| Example 5 | In_{0.4}Ga_{0.6}N | 5 | ZnS | Hexadecylamine | Zirconium phosphate | 405 | 520 | 90 |
| Example 6 | InP | 2 | ZnS | Hexadecylamine | Vanadium oxide | 405 | 520 | 100 |
| Example 7 | In_{0.7}Ga_{0.3}P | 3 | GaN | Trioctylamine | Vanadium oxide | 405 | 600 | 95 |
| Example 8 | InN | 5 | GaN/ZnS | Dodecanethiol | Vanadium oxide | 405 | 620 | 95 |
| Comparative | InN | 5 | GaN | Trioctylphosphine | — | 405 | 620 | 30 |
| example 1 | | | | | | | | |

### Example 2

In the present Example, a semiconductor phosphor nanoparticle capable of absorbing excitation light to emit green light was produced by a hot soap method. Such a semiconductor phosphor nanoparticle includes a semiconductor crystalline particle made of InN, a modified organic compound made of dodecanethiol (DT) and a layered compound made of molybdenum oxide. A method for producing the same will be described specifically below.

First, a semiconductor crystalline particle made of an InN crystal was synthesized by a thermal decomposition reaction of 1 mmol of tris(dimethylamino)indium and 3 mmol of DT in 30 ml of a 1-octadecene solution. By adjusting a mean particle diameter of the semiconductor crystalline particle to 4 nm, a luminous wavelength was adjusted to 520 nm so as to exhibit green luminescence. The mean particle diameter of the semiconductor crystalline particle obtained above was calculated by using the same Scherrer's expression (Mathematical expression (2)) as in Example 1. As a result, the mean particle diameter was found to be 4 nm.

Next, the reaction was performed by adding a layered molybdenum oxide prepared in ethanol to a solution containing the semiconductor crystalline particle obtained above dispersed therein to produce a semiconductor phosphor nanoparticle with a constitution of InN (semiconductor crystalline particle)/DT (modified organic compound)/MoO (layered compound).

The semiconductor phosphor nanoparticle thus produced can be used as a green phosphor since it particularly absorbs light having a particularly high external quantum efficiency and a wavelength of 405 nm using a blue light emitting device made of a 13th family nitride as an excitation light source to emit green light.

Relative to the semiconductor phosphor nanoparticle obtained in Example 2, a luminous intensity of light having a wavelength of 520 nm was measured in the same manner as in Example 1. As a result, a high luminous intensity of about 70 a.u. was obtained. Thus, it has found that the semiconductor phosphor nanoparticle of Example 2 exhibits the quantum size effect and has a high luminous efficiency. It is considered that a surface defect of the semiconductor crystal was stably capped by coating the surface of the semiconductor crystalline particle with the modified organic compound and the layered compound.

### Example 3

In the present Example, a semiconductor phosphor nanoparticle capable of absorbing excitation light to emit blue light was produced by a hot soap method. Such a semiconductor phosphor nanoparticle includes a semiconductor crystal core made of InN, a shell layer made of ZnS, a modified organic compound made of octylamine (OA) and a layered compound made of molybdenum disulfide. A method for producing the same will be described specifically below.

First, a semiconductor crystal core made of an InN crystal was synthesized by a thermal decomposition reaction of 1 mmol of tris(dimethylamino)indium and 4 mmol of OA in 30 ml of a 1-octadecene solution. By adjusting a mean particle diameter of the semiconductor crystal core to 3 nm, a luminous wavelength was adjusted to 470 nm so as to exhibit blue luminescence. The mean particle diameter of the semiconductor crystalline particle obtained above was calculated by using the same Scherrer's expression (Mathematical expression (2)) as in Example 1. As a result, the mean particle diameter was found to be 3 nm.

Next, the reaction was performed by adding 30 ml of a 1-octadecene solution containing 3 mmol of zinc acetate and 3 mmol of sulfur as raw materials of the shell to a solution containing the semiconductor crystal core produced above dispersed therein. Then, the reaction was performed by adding a layered molybdenum disulfide prepared in ethanol to produce a semiconductor phosphor nanoparticle with a constitution of InN (semiconductor crystal core)/ZnS (shell layer)/OA (modified organic compound)/MoS₂ (layered compound).

The semiconductor phosphor nanoparticle thus produced can be used as a blue phosphor since it particularly absorbs light having a particularly high external quantum efficiency and a wavelength of 405 nm using a blue light emitting device made of a 13th family nitride as an excitation light source to emit blue light.

Relative to the semiconductor phosphor nanoparticle obtained in the present Example, a luminous intensity of light having a wavelength of 470 nm was measured. As a result, a high luminous intensity of about 80 a.u. was obtained. Thus, it has found that the semiconductor phosphor nanoparticle of the present Example exhibits the quantum size effect and has a high luminous efficiency. It is considered that a surface defect of the semiconductor crystalline particle was stably capped by coating the surface of the shell layer with the modified organic compound and the layered compound.

### Example 4

In the present Example, a semiconductor phosphor nanoparticle capable of absorbing excitation light to emit blue light was produced by a hot soap method. Such a semiconductor phosphor nanoparticle includes a semiconductor crystal core made of In_{0.3}Ga_{0.7}N, a shell layer made of GaN, a modified organic compound made of trioctylamine (TOA) and a layered compound made of manganese oxide. A method for producing the same will be described specifically below.

First, a semiconductor crystal core made of an In_{0.3}Ga_{0.7}N crystal was synthesized by a thermal decomposition reaction of 0.3 mmol of tris(dimethylamino)indium, 0.7 mmol of tris(dimethylamino)gallium and 2 mmol of TOA in 30 ml of a 1-octadecene solution. By adjusting a mean particle diameter of the semiconductor crystal core to 5 nm, a luminous wavelength was adjusted to 480 nm so as to exhibit blue luminescence. The mean particle diameter of the semiconductor crystalline particle obtained above was calculated by using the same Scherrer's expression (Mathematical expression (2)) as in Example 1. As a result, the mean particle diameter was found to be 5 nm.

Next, the reaction was performed by adding 30 ml of a 1-octadecene solution containing 7 mmol of tris(dimethylamino)gallium as a raw material of the shell layer to a solution containing the semiconductor crystal core obtained above dispersed therein. The reaction was performed by adding a layered manganese oxide prepared in ethanol to produce a semiconductor phosphor nanoparticle with a constitution of In_{0.3}Ga_{0.7}N (semiconductor crystal core)/GaN (shell layer)/TOA (modified organic compound)/MnO (layered compound).

The semiconductor phosphor nanoparticle thus produced can be used as a blue phosphor since it particularly absorbs light having a particularly high external quantum efficiency and a wavelength of 405 nm using a blue light emitting device made of a 13th family nitride as an excitation light source to emit blue light.

Relative to the semiconductor phosphor nanoparticle obtained in the present Example, a luminous intensity of light having a wavelength of 480 nm was measured. As a result, a high luminous intensity of about 85 a.u. was obtained. Thus, it has found that the semiconductor phosphor nanoparticle of the present Example exhibits the quantum size effect and has a high luminous efficiency. It is considered that a surface defect of the semiconductor crystalline particle was stably capped by coating the surface of the shell layer with the modified organic compound and the layered compound.

### Example 5

In the present Example, a semiconductor phosphor nanoparticle capable of absorbing excitation light to emit green light was produced by a hot soap method. Such a semiconductor phosphor nanoparticle includes a semiconductor crystal core made of In_{0.4}Ga_{0.6}N, a shell layer made of ZnS, a modified organic compound made of HDA and a layered compound made of zirconium phosphate. A method for producing the same will be described specifically below.

First, a semiconductor crystal core made of an In_{0.4}Ga_{0.6}N crystal was synthesized by a thermal decomposition reaction of 0.4 mmol of tris(dimethylamino)indium, 0.6 mmol of tris(dimethylamino)gallium and 2 mmol of HDA in 30 ml of a 1-octadecene solution. By adjusting a mean particle diameter of the semiconductor crystal core to 5 nm, a luminous wavelength was adjusted to 520 nm so as to exhibit green luminescence. The mean particle diameter of the semiconductor crystalline particle obtained above was calculated by using the same Scherrer's expression (Mathematical expression (2)) as in Example 1. As a result, the mean particle diameter was found to be 5 nm.

Next, the reaction was performed by adding 30 ml of a 1-octadecene solution containing 7 mmol of zinc acetate and 7 mmol of sulfur as raw materials of the shell layer to a solution containing the semiconductor crystal core obtained above dispersed therein. Then, the reaction was performed by adding a layered zirconium phosphate prepared in ethanol to produce a semiconductor phosphor nanoparticle with a constitution of In_{0.4}Ga_{0.6}N (semiconductor crystal core)/ZnS (shell layer)/HDA (modified organic compound)/Zr(HPO₄)₂ (layered compound).

The semiconductor phosphor nanoparticle thus produced can be used as a green phosphor since it particularly absorbs light having a particularly high external quantum efficiency and a wavelength of 405 nm using a blue light emitting device made of a 13th family nitride as an excitation light source to emit green light.

Relative to the semiconductor phosphor nanoparticle obtained in the present Example, a luminous intensity of light having a wavelength of 520 nm was measured. As a result, a high luminous intensity of about 90 a.u. was obtained. Thus, it has found that the semiconductor phosphor nanoparticle of the present Example exhibits the quantum size effect and has a high luminous efficiency. It is considered that a surface defect of the semiconductor crystalline particle was stably capped by coating the surface of the shell layer with the modified organic compound and the layered compound.

### Example 6

In the present Example, a semiconductor phosphor nanoparticle capable of absorbing excitation light to emit green light was produced by a hot soap method. Such a semiconductor phosphor nanoparticle includes a semiconductor crystal core made of InP, a shell layer made of ZnS, a modified organic compound made of HDA and a layered compound made of vanadium oxide. A method for producing the same will be described specifically below.

First, a semiconductor crystal core made of an InP crystal was synthesized by a thermal decomposition reaction of 1 mmol of indium trichloride, 1 mmol of tris(trimethylsilylphosphine) and 5 mmol of HDA in 30 ml of a 1-octadecene solution. By adjusting a mean particle diameter of the semiconductor crystal core to 2 nm, a luminous wavelength was adjusted to 520 nm so as to exhibit green luminescence. The mean particle diameter of the semiconductor crystalline particle obtained above was calculated by using the same Scherrer's expression (Mathematical expression (2)) as in Example 1. As a result, the mean particle diameter was found to be 2 nm.

Next, the reaction was performed by adding 30 ml of a 1-octadecene solution containing 1.6 mmol of zinc acetate and 1.6 mmol of sulfur as raw materials of the shell layer to a solution containing the semiconductor crystal core obtained above dispersed therein. Then, the reaction was performed by adding a layered vanadium oxide prepared in ethanol to produce a semiconductor phosphor nanoparticle with a constitution of InP (semiconductor crystal core)/ZnS (shell layer)/HDA (modified organic compound)/V₂O₅ (layered compound).

The semiconductor phosphor nanoparticle thus produced can be used as a green phosphor since it particularly absorbs light having a particularly high external quantum efficiency and a wavelength of 405 nm using a blue light emitting device made of a 13th family nitride as an excitation light source to emit green light.

Relative to the semiconductor phosphor nanoparticle obtained in the present Example, a luminous intensity of light having a wavelength of 520 nm was measured. As a result, a high luminous intensity of about 100 a.u. was obtained. Thus, it has found that the semiconductor phosphor nanoparticle of the present Example exhibits the quantum size effect and has a high luminous efficiency. It is considered that a surface defect of the semiconductor crystalline particle was stably capped by coating the surface of the shell layer with the modified organic compound and the layered compound.

### Example 7

In the present Example, a semiconductor phosphor nanoparticle capable of absorbing excitation light to emit red light was produced by a hot soap method. Such a semiconductor phosphor nanoparticle includes a semiconductor crystal core made of In_{0.7}Ga_{0.3}P, a shell layer made of GaN, a modified organic compound made of TOA and a layered compound made of vanadium oxide. A method for producing the same will be described specifically below.

First, a semiconductor crystal core made of an In_{0.7}Ga_{0.3}P crystal was synthesized by a thermal decomposition reaction of 0.3 mmol of gallium trichloride, 0.7 mmol of indium trichloride, 1 mmol of tris(trimethylsilylphosphine) and 4 mmol of TOA in 30 ml of a 1-octadecene solution. By adjusting a mean particle diameter of the semiconductor crystal core to 3 nm, a luminous wavelength was adjusted to 600 nm so as to exhibit red luminescence. The mean particle diameter of the semiconductor crystalline particle obtained above was calculated by using the same Scherrer's expression (Mathematical expression (2)) as in Example 1. As a result, the mean particle diameter was found to be 3 nm.

Next, the reaction was performed by adding 30 ml of a 1-octadecene solution containing 3 mmol of tris(dimethylamino)gallium as a raw material of the shell layer to a solution containing the semiconductor crystal core obtained above dispersed therein. The reaction was performed by adding a layered vanadium oxide prepared in ethanol to produce a semiconductor phosphor nanoparticle with a constitution of In_{0.7}Ga_{0.3}P (semiconductor crystal core)/GaN (shell layer)/HDA (modified organic compound)/V₂O₅ (layered compound).

The semiconductor phosphor nanoparticle thus produced can be used as a red phosphor since it particularly absorbs light having a particularly high external quantum efficiency and a wavelength of 405 nm using a blue light emitting device made of a 13th family nitride as an excitation light source to emit red light.

Relative to the semiconductor phosphor nanoparticle obtained in the present Example, a luminous intensity of light having a wavelength of 600 nm was measured. As a result, a high luminous intensity of about 95 a.u. was obtained. Thus, it has found that the semiconductor phosphor nanoparticle of the present Example exhibits the quantum size effect and has a high luminous efficiency. It is considered that a surface defect of the semiconductor crystalline particle was stably capped by coating the surface of the shell layer with the modified organic compound and the layered compound.

### Example 8

In the present Example, a semiconductor phosphor nanoparticle capable of absorbing excitation light to emit red light was produced by a hot soap method. Such a semiconductor phosphor nanoparticle includes a semiconductor crystal core made of InN, a shell layer having a laminate structure where GaN and ZnS are laminated, a modified organic compound made of dodecanethiol (DT) and a layered compound made of vanadium oxide. In the shell layer, a GaN layer constituted a first shell as an inner shell, while ZnS constituted a second shell as an outer shell. A method for producing the same will be described specifically below.

First, a semiconductor crystal core made of an InN crystal was synthesized by a thermal decomposition reaction of 1 mmol of tris(dimethylamino)indium and 2 mmol of DT in 30 ml of a 1-octadecene solution. By adjusting a mean particle diameter of the semiconductor crystal core to 5 nm, a luminous wavelength was adjusted to 620 nm so as to exhibit red luminescence. The mean particle diameter of the semiconductor crystalline particle obtained above was calculated by using the same Scherrer's expression (Mathematical expression (2)) as in Example 1. As a result, the mean particle diameter was found to be 5 nm.

Next, the reaction was performed by adding 30 ml of a 1-octadecene solution containing 7 mmol of tris(dimethylamino)gallium as a raw material of the first shell layer to a solution containing the semiconductor crystal core obtained above dispersed therein and, furthermore, the reaction was performed by adding 30 ml of a 1-octadecene solution containing 7 mmol of zinc acetate and 7 mmol of sulfur as raw materials of the second shell. Then, the reaction was performed by adding to this solution a layered vanadium oxide prepared in ethanol to produce a semiconductor phosphor nanoparticle with a constitution of InN (semiconductor crystal core)/GaN (first shell)/ZnS (second shell)/HDA (modified organic compound)/V₂O₅ (layered compound).

The semiconductor phosphor nanoparticle thus produced can be used as a red phosphor since it particularly absorbs light having a particularly high external quantum efficiency and a wavelength of 405 nm using a blue light emitting device made of a 13th family nitride as an excitation light source to emit red light.

Relative to the semiconductor phosphor nanoparticle obtained in the present Example, a luminous intensity of light having a wavelength of 620 nm was measured. As a result, a high luminous intensity of about 95 a.u. was obtained. Thus, it has found that the semiconductor phosphor nanoparticle of the present Example exhibits the quantum size effect and has a high luminous efficiency. It is considered that the semiconductor crystalline particle was effectively protected since the shell layer has a laminate structure, and that a surface defect of the shell layer were stably capped by coating the surface of the shell layer with the modified organic compound and the layered compound.

### Comparative Example 1

In the present Comparative example, a semiconductor phosphor nanoparticle capable of absorbing excitation light to emit red light was produced by a hot soap method. FIG. 3 is a view schematically showing a basic structure of a semiconductor phosphor nanoparticle produced in Comparative example 1. As shown in FIG. 3, a semiconductor phosphor nanoparticle 30 of the present Comparative example includes a semiconductor crystal core 33 made of InN, a shell layer 35 made of GaN and a modified organic compound 32 made of trioctylphosphine (TOP). A method for producing the same will be described specifically below.

First, semiconductor crystal core 33 made of an InN crystal was synthesized by a thermal decomposition reaction of 1 mmol of tris(dimethylamino)indium and 2 mmol of TOP in 30 ml of a 1-octadecene solution. By adjusting a mean particle diameter of semiconductor crystal core 33 to 5 nm, a luminous wavelength was adjusted to 620 nm so as to exhibit red luminescence. The mean particle diameter of the semiconductor crystalline particle obtained above was calculated by using the same Scherrer's expression (Mathematical expression (2)) as in Example 1. As a result, the mean particle diameter was found to be 5 nm.

Next, the reaction was performed by adding 30 ml of a 1-octadecene solution containing 7 mmol of tris(dimethylamino)gallium as a raw material of shell layer 35 to a solution containing semiconductor crystal core 33 obtained above dispersed therein to produce semiconductor phosphor nanoparticle 30 with a constitution of InN (semiconductor crystal core 33)/GaN (shell layer 35)/TOP (modified organic compound 32). Modified organic compound 32 was bound with a metal element constituting shell layer 35.

Relative to the semiconductor phosphor nanoparticle obtained in the present Comparative example, a luminous intensity of light having a wavelength of 620 nm was measured. As a result, a high luminous intensity of about 30 a.u. was obtained. That is, the semiconductor phosphor nanoparticle of Comparative example 1 exhibited the luminous intensity lower than those of the semiconductor phosphor nanoparticles of Examples 1 to 8.

Accordingly, it has become apparent that the semiconductor phosphor nanoparticle of Comparative example 1 exhibits the luminous intensity lower than those of the semiconductor phosphor nanoparticles of Examples 1 to 8. It is considered that since a surface of the semiconductor crystalline particle is coated only with the modified organic compound and is not coated with the layered compound in the semiconductor phosphor nanoparticle obtained in Comparative example 1, a surface defect of the semiconductor crystalline particle is not sufficiently protected.

The semiconductor phosphor nanoparticle to be provided by the present invention is suitably used, for example, for blue LED because of excellent luminous efficiency and dispersibility.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A semiconductor phosphor nanoparticle comprising:
a semiconductor crystalline particle made of a 13th family-15th family semiconductor,
a modified organic compound binding to said semiconductor crystalline particle, and
a layered compound sandwiching said semiconductor crystalline particle protected with said modified organic compound.

2. The semiconductor phosphor nanoparticle according to claim 1, wherein said layered compound is made of a metal oxide.

3. The semiconductor phosphor nanoparticle according to claim 1, wherein said semiconductor crystalline particle has a mean particle diameter that is two times or less the Bohr radius.

4. The semiconductor phosphor nanoparticle according to claim 1, wherein said semiconductor crystalline particle is made of a 13th family nitride semiconductor.

5. The semiconductor phosphor nanoparticle according to claim 1, wherein said semiconductor crystalline particle is made of indium nitride.

6. The semiconductor phosphor nanoparticle according to claim 1, wherein said semiconductor crystalline particle is made of a 13th family mixed crystal nitride semiconductor.

7. The semiconductor phosphor nanoparticle according to claim 1, wherein said modified organic compound has a hetero atom.

8. The semiconductor phosphor nanoparticle according to claim 1, wherein said modified organic compound is amine.

9. The semiconductor phosphor nanoparticle according to claim 1, wherein said modified organic compound has a straight-chain alkyl group.

10. The semiconductor phosphor nanoparticle according to claim 1, wherein said semiconductor crystalline particle comprises a semiconductor crystal core, and a shell layer coating the semiconductor crystal core.

11. The semiconductor phosphor nanoparticle according to claim 10, wherein said shell layer has a laminate structure composed of two or more layers.
